(19) United States
(12) Patent Application Publication
(10) Pub. No.: US 2026/0075426 A1
(43) Pub. Date: Mar. 12, 2026

(54) MULTI-MODEL ARTIFICIAL INTELLIGENCE-BASED SCAM CHECKER

(71) Applicant: Trend Micro Incorporated, Tokyo (JP)

(72) Inventors: Yi-Fen CHEN, Pasadena, CA (US); Yen-Ying HUANG, Taipei (TW); Jing-Lin WU, Taipei (TW); Ming-Cheng PAN, Taipei (TW)

(21) Appl. No.: 19/285,990

(22) Filed: Jul. 30, 2025

Related U.S. Application Data
(60) Provisional application No. 63/692,842, filed on Sep. 10, 2024.

(51) Int. Cl. H04W 12/30; H04W 12/122

(52) U.S. Cl. CPC H04W 12/35; H04W 12/122

(57) ABSTRACT

Disclosed is a scam checker for checking contents for scams. The scam checker includes several artificial intelligence (AI) models to decompose an input content, generate a plan for collecting evidence for determining whether the input content is indicative of a scam, collect the evidence, and evaluate the collected evidence to generate a summary that indicates whether the input content is indicative of a scam.

### CROSS-REFERENCE TO RELATED APPLICATION

This application claims the benefit of U.S. Provisional Application No. 63/692,842, filed Sep. 10, 2024, which is incorporated herein by reference in its entirety.

### TECHNICAL FIELD

The present disclosure is directed to cybersecurity.

### BACKGROUND

In cybersecurity, a scam is a fraudulent scheme that deceives individuals into revealing sensitive information, transferring money, or compromising their security. These scams often employ social engineering tactics, where attackers exploit the victim's trust or sense of urgency to achieve their malicious objectives. Common examples of cybersecurity scams include deceptive websites, phone calls, text messages, and social media posts, all designed to exploit human vulnerabilities rather than technical flaws.

A significant challenge in detecting cybersecurity scams is the difficulty of obtaining and checking user data for potential scams. For instance, scam checking a user's social media account can be problematic due to privacy concerns and difficulty of directly accessing the user's device, which is typically a smartphone. Therefore, there is a need for a solution that enables users to conveniently perform scam checks while addressing these challenges.

### BRIEF SUMMARY

Disclosed is a scam checker for checking contents for scams. The scam checker includes a plurality of artificial intelligence (AI) models to decompose an input content, generate a plan for collecting evidence for determining whether the input content is indicative of a scam, collect the evidence, and evaluate the collected evidence to generate a summary that indicates whether the input content is indicative of a scam. The input content may be a screenshot, a video or audio recording, text, or other content on a user device, such as a smartphone, a wearable device, or other computer employed by the user. The input content may be from social media posts, webpages of websites, phone calls, or other digital content received by the user on the user device.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a flow diagram of a method of checking contents for scams, in accordance with an embodiment of the present invention.

FIG. 2 shows a flow diagram of a method of preprocessing an input content, in accordance with an embodiment of the present invention.

FIG. 3 shows an example screenshot taken on a user device for scam check, in accordance with an embodiment of the present invention.

FIG. 4 shows another example screenshot taken on a user device for scam check, in accordance with an embodiment of the present invention.

FIG. 5 shows an example prompt that may be input to an artificial intelligence (AI) planning model, in accordance with an embodiment of the present invention.

FIG. 6 shows an example response from an AI planning model, in accordance with an embodiment of the present invention.

FIG. 7 shows an example summary from an AI reasoning model, in accordance with an embodiment of the present invention.

FIG. 8 shows a flow diagram of a method of checking contents for scams, in accordance with an embodiment of the present.

FIGS. 9-14 show examples of scam checking, in accordance with embodiments of the present invention.

FIGS. 15-17 show various deployment scenarios for scam checking, in accordance with embodiments of the present invention.

FIG. 18 shows a flowchart of a method of checking an input content for scams, in accordance with an embodiment of the present invention.

FIG. 19 shows a block diagram of a computer system that may be employed with embodiments of the present invention.

### DETAILED DESCRIPTION

In the present disclosure, numerous specific details are provided, such as examples of systems, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

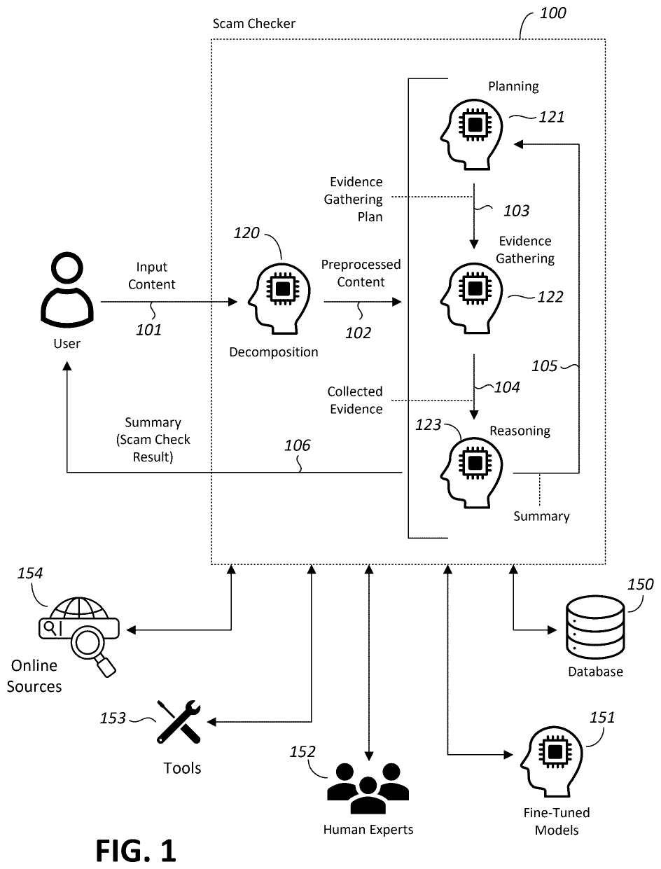

FIG. 1 shows a flow diagram of a method of checking contents for scams, in accordance with an embodiment of the present invention. In the example of FIG. 1, a scam checker 100 checks input content for cybersecurity scams, that is, scams occurring on digital platforms and technologies. The scam checker 100 includes a plurality of artificial intelligence (AI) models, which in one embodiment comprises a decomposition model 120, a planning model 121, an evidence gathering model 122, and a reasoning model 123. The models 120 to 123 may include a large language model (LLM), a vision language model (VLM), a multimodal language model (MLM), or any other suitable AI model. An AI model may include, for example, a generative model, a discriminative model, an encoder-only model, an encoder-decoder model, or another type of machine learning or deep learning model depending on implementation particulars.

In the example of FIG. 1, the scam checker 100 receives input content from a user (see arrow 101). In the scam checker 100, the decomposition model 120 performs preprocessing and feature extraction on the input content. In one embodiment, the decomposition model 120 is configured to decompose the input content into its constituent data modalities, and, in some embodiments, determine the communicated purpose and context of the content. Input content may be text, image, audio, or video. The data modalities depend on the input content and may include text, image data, and audio data. An image may be decomposed into text and image data. Audio may be decomposed into audio data and text. Video may be decomposed into video frames and corresponding audio, which may be further decomposed into image data and audio data, respectively.

In some embodiments, the decomposition model 120 is further configured to infer a communicated purpose of the input content, i.e., what the content is trying to convey. For example, in a short message service (SMS) message, the decomposition model 120 may determine whether the text of the SMS message is reminding the user of a medical appointment, asking for money, etc. In that example, the decomposition model 120 may be an LLM that has been trained and/or fine-tuned using samples of texts of varying communicated purposes. The decomposition model 120 may also be a VLM or MLM depending on the input content. Generally, the scam checker 100 may have several AI models to accommodate different types of input content.

In some embodiments, the decomposition model 120 may also infer a context of the input content, which refers to the surrounding circumstances or metadata available at the time the content was received or captured. Contextual information may include the type of application that received the content (e.g., a messaging app or email client), the identity or address of the sender, the timestamp of receipt, or any indicators that are available. For example, in the case of a screenshot from a messaging app, the context may be inferred from the visible header (e.g., sender name) or interface elements (e.g., time-of-message). The decomposition model 120 generates a preprocessed content, which may comprise the data modalities of the input content, the communicated purpose of the input content, and/or the context of the input content (see arrow 102). The preprocessed content is made available to the models 121 to 123.

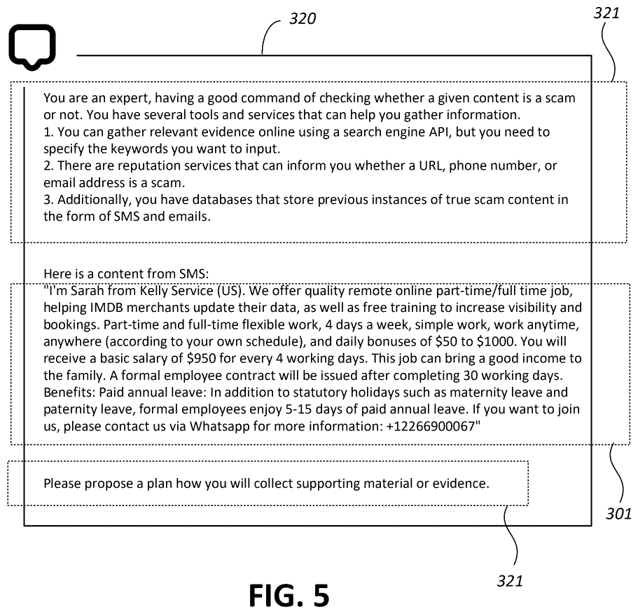

The planning model 121 is configured to receive the preprocessed content and to generate an evidence gathering plan (see arrow 103) for collecting data that may support a determination of whether the input content is indicative of a scam. The evidence gathering plan may identify specific elements of the input content, such as Uniform Resource Locators (URLs), phone numbers, email addresses, image features, or key phrases, that require verification or further analysis. The planning model 121 may also take into account the inferred communicated purpose or context, when available, to determine the most appropriate fact-checking strategy or data sources. For example, if the content is classified as a financial solicitation, the plan may prioritize checking the reputation of the sender or linked domains. The planning model 121 may be implemented using an LLM that receives a structured prompt (e.g., see FIG. 5, prompt 320) defining its role, task objectives, and access to specific tools or resources for evidence collection.

The evidence gathering model 122 is configured to collect evidence in accordance with the evidence gathering plan generated by the planning model 121. The evidence gathering model 122 may be provided access to a variety of resources that enable the retrieval, analysis, or generation of evidence relevant to scam detection. Such resources may include: a database 150 of known scams or historical patterns; fine-tuned models 151 that analyze images, text, audio, or other modalities; human experts 152 who may assist in ambiguous cases; tools 153 for processing or evaluating content; and online sources 154, such as reputation services, search engines, or domain registries. These resources may be accessed over a computer network, including the public Internet. The evidence gathering model 122 may select and invoke these resources based on the structure of the evidence gathering plan, and may operate autonomously or in conjunction with other models or components of the scam checker 100.

The database 150 may include patterns, examples, and other data for Retrieval-Augmented Generation (RAG). The fine-tuned models 151 may comprise LLMs and other AI models that are fine-tuned to recognize or understand scam content. The human experts 152 may be cybersecurity experts that may be asked by the evidence gathering model 122 to answer particular questions (e.g., by sending a text or email). The tools 153 may include a reputation service, a fact check service, a tool for detecting modifications to content or AI-generated content, and other verification tools. The online sources 154 may be websites, servers, search engine application programming interfaces (APIs), or other systems or services that are accessible over the public Internet and have information relevant to the input content.

The evidence gathering model 122 provides the collected evidence to the reasoning model 123 (see arrow 104). The reasoning model 123 generates a summary based on the collected evidence. The reasoning model 123 may be trained or fine-tuned using examples of known scam content and corresponding classifications. The summary may include a conclusion indicating whether the input content is indicative of a scam, along with an explanation of the reasoning that led to that conclusion. The reasoning may reference relevant evidence, such as suspicious URLs, fake branding, or known scam indicators, that support the determination. The summary is provided to the user as the scam check result (see arrow 106).

The process of checking the input content for scams may be iterative. In some cases, the reasoning model 123 may determine that additional information is needed before a final summary can be generated, and may request further evidence collection (see arrow 105). For example, in the first round of scam checking, the evidence gathering model 122 may have collected information from a webpage that has an email address. In that case, information about the email address may be collected before a summary is generated and provided to the user.

Some scam campaigns are tailored to specific geographic regions. For example, scams that are prevalent in certain parts of Asia may be uncommon in North America. To address this, the scam checker 100 may be optimized for regional relevance. In particular, the datasets used to train, fine-tune, or configure the models 120 through 123 may be derived from known scams that are specific to the geographic region in which the user is located. This regional tuning advantageously improves the effectiveness and accuracy of the scam checker 100 for users in different parts of the world.

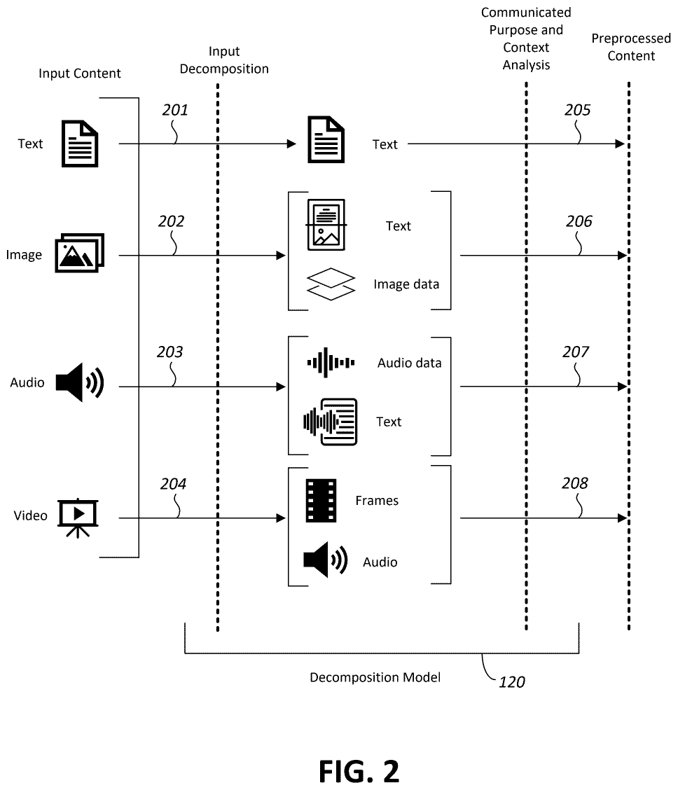

FIG. 2 shows a flow diagram of a method of preprocessing an input content, in accordance with an embodiment of the present invention. The method of FIG. 2 is performed by the decomposition model 120. In the example of FIG. 2, the decomposition model 120 receives input content, which may be text, image, audio, or video. The input content may be received by the decomposition model 120 as a screenshot, a video recording, an audio recording, or other digital content.

The decomposition model 120 decomposes an input content into its constituent data modalities. Text input does not necessarily need decomposition, and may thus be passed to the planning model 121 as is (see arrow 201).

An image may be in the native format of the image recording device (e.g., RAW format) or in processed format (e.g., JPEG, TIFF, BMP, etc.). The image may be decomposed into image data (e.g., pixel-level information) and corresponding text (see arrow 202). The text of the image refers to characters that are visually present within the image. As a particular example, the decomposition model 120 may receive a screenshot of an SMS message, and decompose the screenshot to text (e.g., by OCR) and image data. This allows text from the screenshot, such as URLs, phone numbers, email addresses, etc., and/or scene information from the image data to be evaluated for scam.

Audio may be in a format natively produced by the recording device or in a processed format, such as MP3, WAV, ALAC, or AIFF. The audio may be decomposed into audio data, such as waveform features or spectral representations, and corresponding text obtained through speech-to-text conversion (see arrow 203).

Video content may be decomposed into a sequence of video frames and an audio track (see arrow 204). Each video frame may be further decomposed into image data and extracted text, for example using optical character recognition, while the audio track may be decomposed into audio data and transcribed text using speech-to-text techniques.

The decomposition model 120 may determine the communicated purpose and context of the input content based on its constituent data modalities. The data modalities, as well as the inferred communicated purpose and context when available, are provided to the planning model 121 as preprocessed content (see arrows 205 to 208).

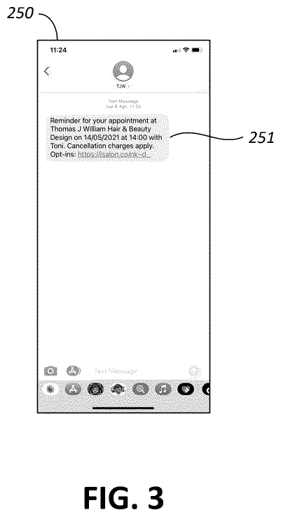

FIG. 3 shows an example screenshot 250 taken on a user device for scam check, in accordance with an embodiment of the present invention. A user device is a device on which a user receives content to be checked for potential scams. In the example of FIG. 3, the user received an SMS message 251 that includes a clickable URL on a smartphone. The screenshot 250 or the text of the SMS message 251 may be input to the scam checker 100 to determine whether the SMS message 251 is a scam message. For example, the decomposition model 120 may decompose the screenshot 250 to image data and corresponding text, determine that the SMS message 251 was received at the timestamp indicated in the screenshot 250, identify the app that received the SMS message 251, identify the sender of the SMS message 251, and detect the communicated purpose (beauty salon appointment in this case) of the SMS message 251. The planning model 121 may generate an evidence gathering plan that includes consulting a web reputation service for a reputation of the clickable link in the SMS message 251 and gathering information about the beauty shop indicated in the SMS message 251. The evidence gathering model 122 may collect evidence as per the evidence gathering plan. The reasoning model 123 may receive the collected evidence and generate a corresponding summary. The summary may indicate that there is a high certainty that the SMS message 251 is part of a scam because the clickable link does not lead to a website of the beauty shop and/or the clickable link has a bad reputation.

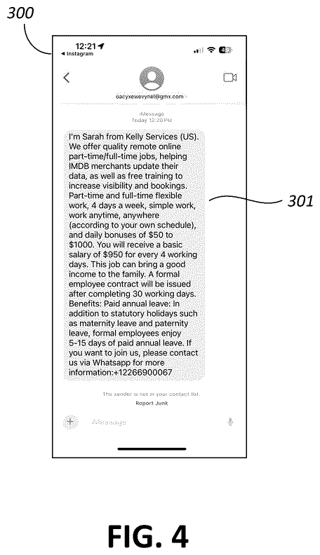

FIG. 4 shows an example screenshot 300 taken on a user device for scam check, in accordance with an embodiment of the present invention. In the example of FIG. 4, the user received a message 301 in an iMessage messaging app on an iPhone™ smartphone. The screenshot 300 or the message 301 may be input to the scam checker 100 to determine whether the message 301 is a scam message. More particularly, the decomposition model 120 may decompose the screenshot 300 into image data and text, and provide the text to the planning model 121. In the example of FIG. 4, the message 301 includes a phone number, name of company, and other information that may be useful for scam checking.

FIG. 5 shows an example prompt 320 that may be input to the planning model 121, in accordance with an embodiment of the present invention. The prompt 320 may be generated using a template with fields for inserting instructions 321 and the input content to be evaluated for scam, which in the example of FIG. 5 is the text extracted from the screenshot 300 of the message 301 (also shown in FIG. 4). The instructions 321 inform the planning model 121 of its role and resources that are available for evidence collection.

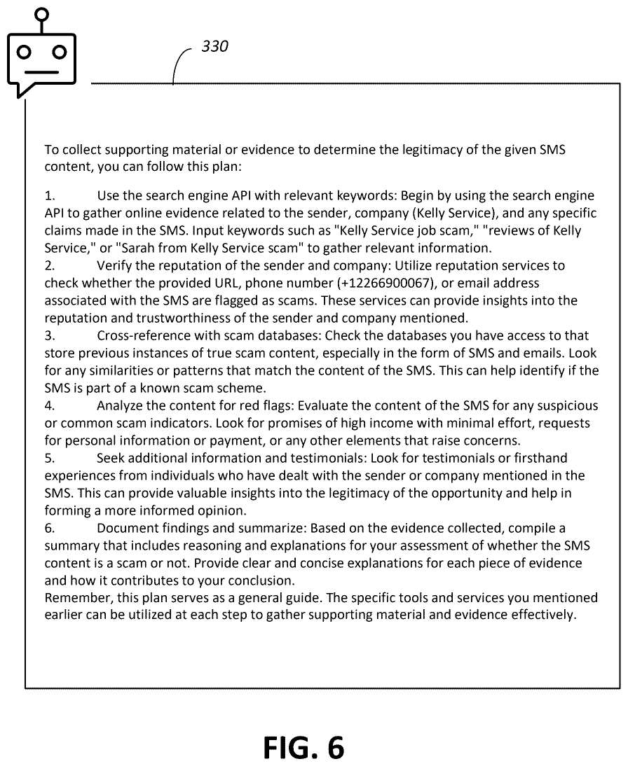

FIG. 6 shows an example response 330 from the planning model 121, in accordance with an embodiment of the present invention. The response 330 is responsive to the prompt 320 of FIG. 5. The response 330 provides an evidence gathering plan on collecting evidence to determine whether the message 301 is part of a scam. In the example of FIG. 6, the evidence gathering plan includes using a search engine application programming interface (API) with relevant keywords taken from the message 301 to gather online evidence related to the sender of the message 301, the Kelly Service company indicated in the message 301, etc. ; utilize a reputation service to check the phone number, URL, etc. in the or associated with the message 301; check the message 301 against scam databases; etc. The evidence gathering plan noted in the response 330 is provided to the evidence gathering model 122, which collects evidence in accordance with the evidence gathering plan. The collected evidence is thereafter provided to the reasoning model 123 for evaluation. The reasoning model 123 generates a summary that corresponds to the collected evidence.

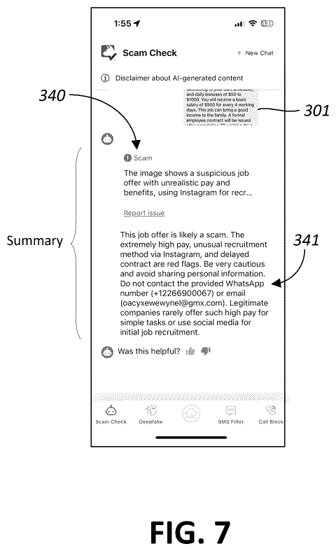

FIG. 7 shows an example summary from the reasoning model 123, in accordance with an embodiment of the present invention. In the example of FIG. 7, the scam checker 100 is embodied as part of a Scam Check app. For example, the scam checker 100 may be hosted by a backend system in the cloud and the Scam Check app serves as a user interface for the scam checker 100. The Scam Check app is running on a smartphone that communicates with the backend system over the public Internet. In the example of FIG. 7, the message 301 (also shown in FIG. 4) is input to the scam checker 100 by way of the Scam Check app. The message 301 may be input to the scam checker 100 as a screenshot (e.g., of a messaging app, social media app) or as text. The scam checker 100 outputs a corresponding summary from the reasoning model 123. The summary includes a conclusion that the message 301 is a scam message (see arrow 340) and reasoning behind the conclusion (see arrow 341). The summary may be in JavaScript Object Notation (JSON) or other format as received from the backend system. The Scam Check app interprets and formats the summary for display on the smartphone.

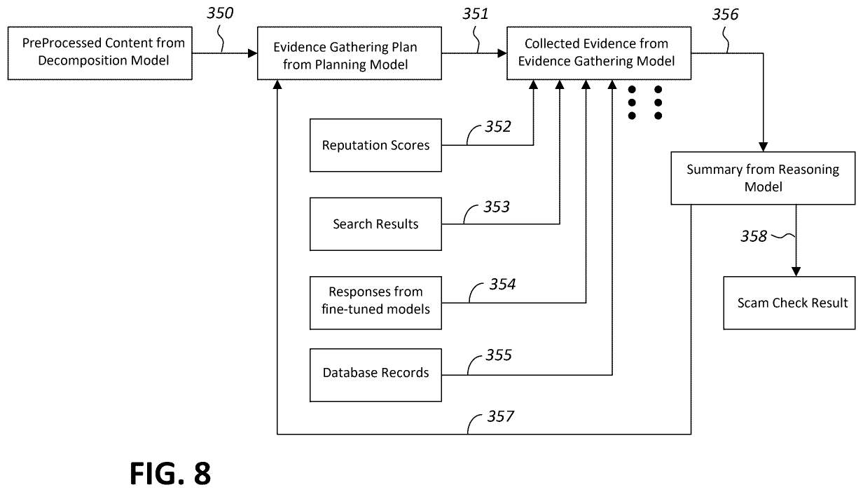

FIG. 8 shows a flow diagram of a method of checking contents for scams, in accordance with an embodiment of the present. The method of FIG. 8 is performed by the scam checker 100. In the example of FIG. 8, the composition model 120 receives an input content from a user, and generates preprocessed content that corresponds to the input content. The preprocessed content comprises constituent data modalities of the input content, an indication of the communicated purpose of the input content, and/or a context of the input content. The preprocessed content is provided to the planning model 121 (see arrow 350), which generates an evidence gathering plan based on the preprocessed content. The evidence gathering model 122 collects evidence for determining whether the input content is indicative of scams in accordance with the evidence gathering plan (see arrow 351). The collected evidence may be reputation scores (see arrow 352), search results (see arrow 353), responses from fine-tuned models (see arrow 354), records of databases (see arrow 355), etc. The collected evidence is input to the reasoning model 123 (see arrow 356). Another round of processing may be performed when the collected evidence needs to be augmented with additional information (see arrow 357). When the collected evidence is deemed sufficient, the reasoning model 123 evaluates the collected evidence for potential scams, and generates a corresponding summary. The summary is provided as a scam check result (see arrow 358) to the user. The summary may include a conclusion that indicates whether the input content is a scam content and a reasoning behind the conclusion.

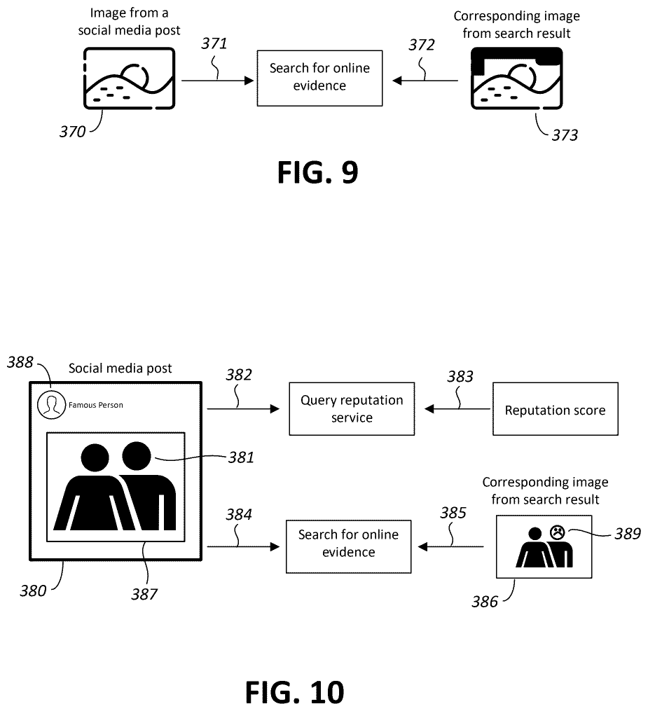

FIGS. 9-14 show examples of scam checking, in accordance with embodiments of the present invention. In the example of FIG. 9, an image 370 appears on a social media post that is viewed by the user. The user inputs the social media post to the scam checker 100. The decomposition model 120 extracts the image 370 from the social media post. The planning model 121 generates an evidence gathering plan that includes searching the public Internet for the image 370. The evidence gathering model 122 searches the public Internet for the image 370 (see arrow 371) and finds the image 373 from the search result (see arrow 372). The reasoning model 123 concludes that the social media post is a scam post partly because the image 373 is very similar to the image 370 (and thus appears in the search result), but the image 370 has a different background and has been taken at a different time of day.

In the example of FIG. 10, the user is viewing a social media post 380 that is supposedly by a famous person (see FIGS. 10, 388). The post 380 includes an image 387 that supposedly includes the famous person (see FIGS. 10, 381). The user inputs a screenshot of the post 380 to the scam checker 100. The decomposition model 120 extracts the image 387 and poster information from the post 380. The planning model 121 generates an evidence gathering plan that includes querying a reputation service (see arrow 382) for the reputation of the poster and searching the public Internet for the image 387 (see arrow 384). The evidence gathering model 122 receives a reputation score for the poster (see arrow 383) and found a closest image 386 from its search result (see arrow 385). The reasoning model 123 concludes that the post 380 is a scam post partly because the image 386 does not include the famous person and that the poster 388 has a low reputation score. In the image 386, another person (see FIGS. 10, 389) is in the position where the famous person is supposed to be in the image 387.

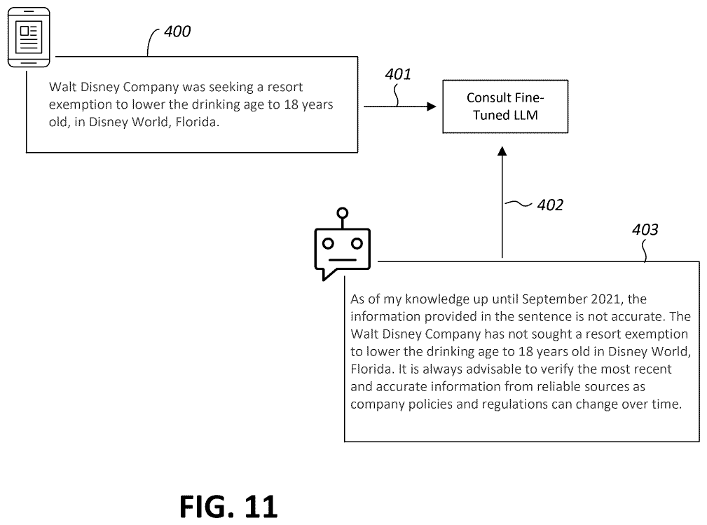

In the example of FIG. 11, a text 400 appears on a smartphone of the user, such as from a text message, social media post, webpage of a news website etc. The text 400 includes information about the Walt Disney Company that the user wants to verify. The user inputs the text 400 to the scam checker 100. The decomposition model 120 passes the text 400 to the planning model 121, which generates an evidence gathering plan that includes consulting an LLM that has been fine-tuned to detect news-related scams. In accordance with the evidence gathering plan, the evidence gathering model 122 inputs the text 400 to the fine-tuned LLM (see arrow 401) and receives a corresponding response 403 (see arrow 402). The evidence gathering model 122 provides the response 403 to the reasoning model 123. The reasoning model 123 concludes that the text 400 is a scam text partly because the text 400 is erroneous according to the response 403 from the fine-tuned LLM.

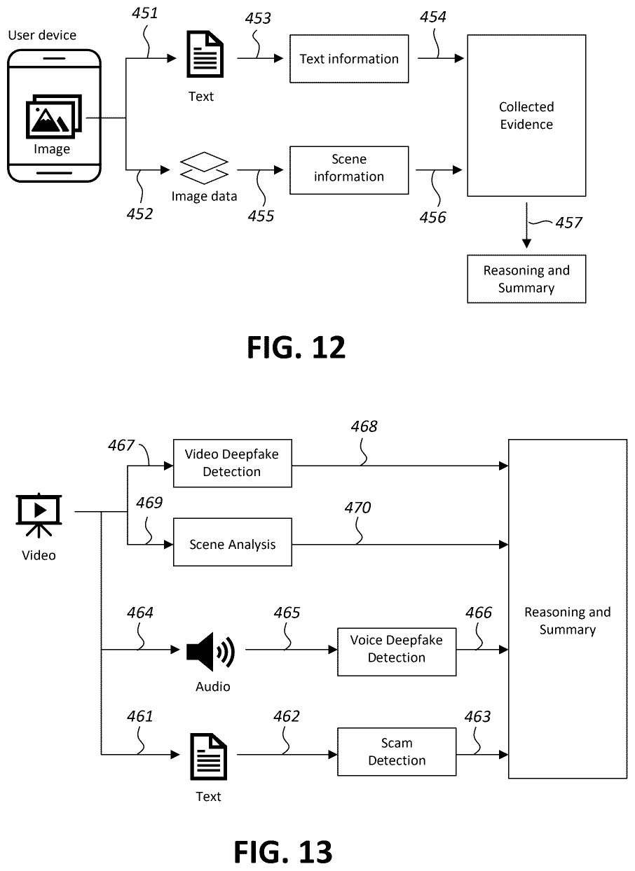

In the example of FIG. 12, the user is viewing an image on a smartphone or other mobile device. The image may be on a messaging app (e.g., Apple iMessage™). The user takes a screenshot of the image and inputs the screenshot to the scam checker 100. The decomposition model 120 decomposes the image into its constituent text (see arrow 451) and image data (see arrow 452). The text may include URLs, phone numbers, email addresses, and other information that is relevant to scam checking (see arrow 453). The image data may include scene information (see arrow 455), such as visual elements or layout features that indicate the type of content shown in the image, for example whether the image resembles a login screen, payment request, or branded communication.

The decomposition model 120 provides the text and image data, along with any available context, communicated purpose, and scene information, to the planning model 121. The planning model 121 generates an evidence gathering plan that may include querying a reputation service to determine the reputation of the URLs, phone numbers, and email addresses, and performing associated online searches. The evidence gathering plan may also include comparing the scene information to image databases and online search results, and consulting fine-tuned models to detect features that are indicative of scam. The evidence gathering model 122 collects evidence in accordance with the evidence gathering plan (see arrows 454 and 456). The reasoning model 123 evaluates the collected evidence for potential scams, and generates a corresponding summary (see arrow 457), which provides a conclusion that indicates whether or not the screenshot of the image is indicative of a scam and a reasoning behind the conclusion.

Embodiments of the present invention may be employed along with other cybersecurity tools to enhance scam check analysis. In the example of FIG. 13, the user receives a video on a smartphone or other mobile device. The video may originate from a messaging app, social media app, or any other application that supports video content. The user inputs the video into the scam checker 100. The decomposition model 120 processes the video to extract constituent text from video frames (see arrow 461) and to isolate the audio track (see arrow 464). The extracted text is analyzed for scam-related content as previously described (see arrow 462). The audio data is further analyzed to determine whether the voice content may be a synthetic or impersonated voice, indicating a possible voice deepfake (see arrow 465). Voice deepfake detection may be performed using conventional deepfake detection techniques, such as analysis of acoustic features, prosody, or spectral patterns using classifiers trained on real and synthetic voice data.

The video content itself may also be analyzed for deepfake manipulation, such as synthetic face generation or tampered frame sequences (see arrow 467). This video deepfake detection may similarly be performed using conventional techniques, including but not limited to convolutional neural networks trained to detect facial artifacts, inconsistencies in motion, or frame-level anomalies. In addition, scene analysis may be performed (see arrow 469) to identify visual elements that provide context, such as apparent app interfaces, brand logos, payment prompts, or other features commonly associated with scams. The results of the voice deepfake detection (see arrow 466), video deepfake detection (see arrow 468), scene analysis (see arrow 470), and text scam detection (see arrow 463) may be incorporated into the summary provided to the user.

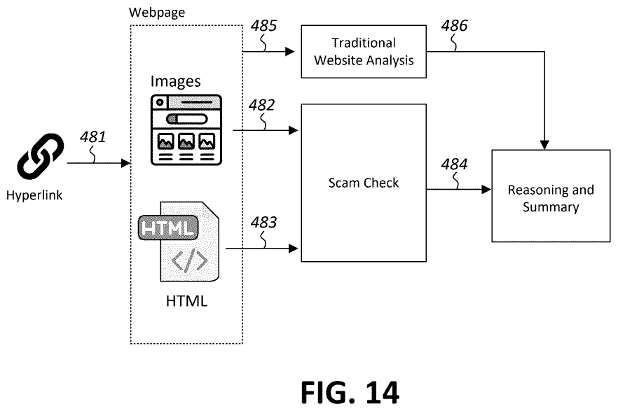

In the example of FIG. 14, a user receives a hyperlink on a smartphone or other user device. The hyperlink may originate from a messaging app, social media app, webpage, email, or any other application that supports hyperlinks. The user inputs the hyperlink into the scam checker 100. The scam checker 100 or an associated cybersecurity module retrieves the webpage pointed to by the hyperlink. Images from the retrieved webpage (see arrow 482) and text content extracted from the HTML of the webpage (see arrow 483) may be analyzed for indicators of scam activity, as described in previous embodiments. In addition, the scam checker 100 or the associated cybersecurity module may perform traditional website analysis (see arrow 485), including inspection of WHOIS information associated with the domain name, determination of the website's reputation score using threat intelligence services, and analysis of related metadata such as Internet Protocol (IP) geolocation or SSL certificate status. The results of the scam check (see arrow 484) and traditional website analysis (see arrow 486) may be incorporated into the summary provided to the user.

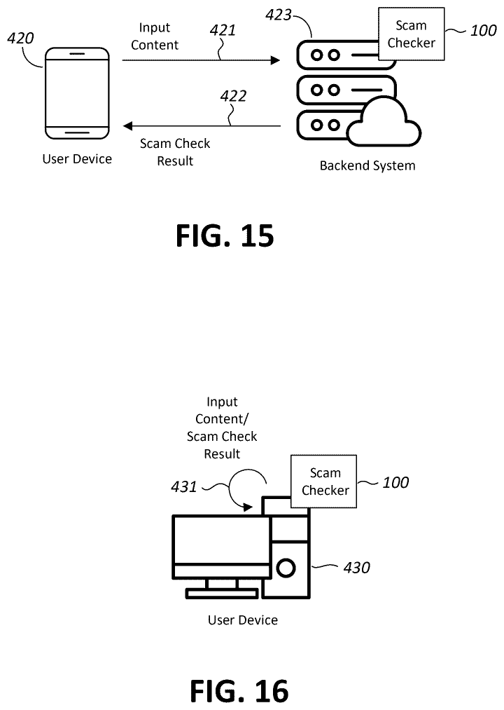

FIGS. 15-17 show various deployment scenarios for scam checking, in accordance with embodiments of the present invention.

In the example of FIG. 15, the scam checker 100 is hosted on a backend system 423 in the cloud. The backend system 423 may be a server computer system, interconnected computer systems, a cloud computing platform (e.g., Amazon Web Services (AWS)™ platform), or other computer system. The user device 420 may be a smartphone or other computing device that communicates with the backend system 423 over the public Internet. As can be appreciated, because the scam checker 100 is hosted in the cloud, the user device 420 does not have to be computationally powerful. The user device 420 transmits input content to the backend system 423 for scam checking (see arrow 421). The input content may be a screenshot, video and/or audio recording, text of an SMS message, or other content received on the user device 420. On the backend system 423, the scam checker 100 checks the input content for scams and returns the result of the scam check to the user device 420 (see arrow 422).

In the example of FIG. 16, the scam checker 100 is hosted on a user device 430. The user device 430 may be an AI personal computer (PC) or other computer system that is capable of running the scam checker 100. The user enters input content to the scam checker 100 to receive a corresponding scam check result (see arrow 431).

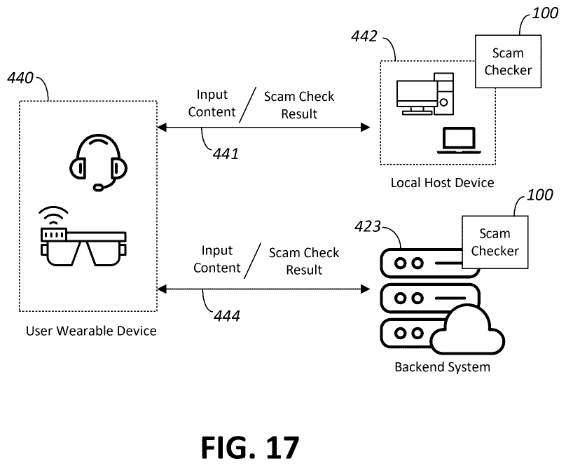

In the example of FIG. 17, the scam checker 100 may be hosted on a local host device 442 or on the backend system 423 in the cloud. The user employs a wearable device 440 to access social media sites, access online websites, make phone and video calls, etc. The local host device 442 may be an AI-capable computing device that is in the immediate vicinity of the user and connected to the wearable device 440 by wired or wireless connection. The wearable device 440 may be a headset, smart glasses, or other wearable computing device. The wearable device 440 may include an interface to extract content, provide the extracted content as input content to the scam checker 100 on the local host device 442 or on the backend system 423, and receive a result of the scam check from the local host device 442 (see arrow 441) or the backend system 423 (see arrow 444).

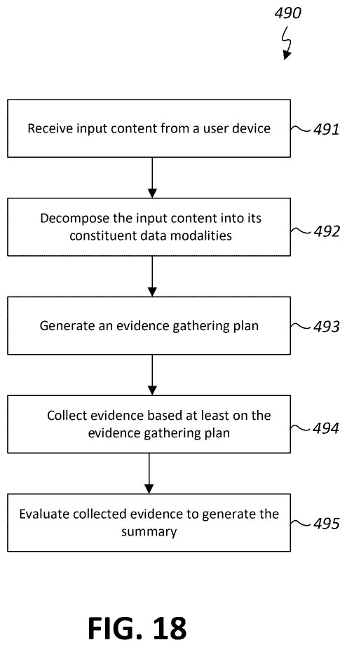

FIG. 18 shows a flowchart of a method 490 of checking an input content for scams, in accordance with an embodiment of the present invention. The method 490 may be performed by the scam checker 100. As can be appreciated, the method 490 may also be performed by other components without detracting from the merits of the present invention.

In step 491, the method 490 includes receiving input content from a user device.

In step 492, the method 490 includes decomposing, by one of a plurality of AI models, the input content to its one or more constituent data modalities.

In step 493, the method 490 includes generating, by one of the plurality of AI models, an evidence gathering plan based at least on the one or more constituent data modalities of the input content.

In step 494, the method 490 includes collecting, by one of the plurality of AI models, evidence based at least on the evidence gathering plan.

In step 495, the method 490 includes evaluating, by one of the plurality of AI models, the collected evidence to generate a summary, wherein the summary includes a conclusion indicating whether the input content is indicative of a scam.

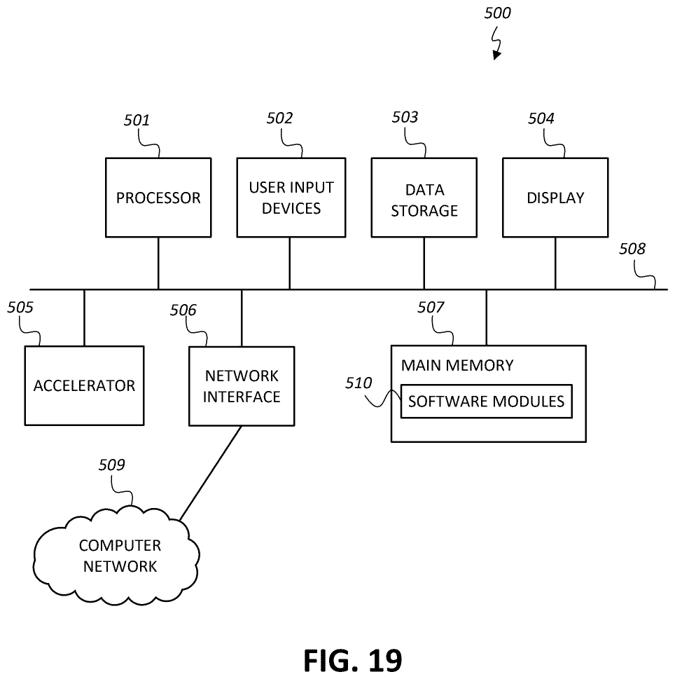

FIG. 19 shows a block diagram of a computer system 500 that may be employed with embodiments of the present invention. The computer system 500 may be employed as a user device, a local host device, a backend system, or other computer. The computer system 500 may have fewer or more components to meet the needs of a particular application. The computer system 500 may include one or more processors 501, one or more user input devices 502 (e.g., keyboard, mouse), one or more data storage devices 503 (e.g., hard drive, optical disk, solid state drive), a display screen 504 (e.g., liquid crystal display, flat panel monitor), one or more accelerators 505 (e.g., graphics processing unit (GPU), neural processing unit (NPU)), a computer network interface 506 (e.g., network adapter, modem), and a main memory 507 (e.g., random access memory). The computer system 500 may have one or more buses 508 coupling its various components. The computer network interface 506 may be coupled to a computer network 509, which in this example includes the public Internet.

The computer system 500 is a particular machine as programmed with one or more software modules 510, comprising instructions stored non-transitory in the main memory 507 for execution by at least one processor 501 to cause the computer system 500 to perform corresponding programmed steps. An article of manufacture may be embodied as computer-readable storage medium including instructions that when executed by at least one processor 501 cause the computer system 500 to be operable to perform the functions of the one or more software modules 510. In one embodiment, the software modules 510 comprise instructions of a scam checker.

While specific embodiments of the present invention have been provided, it is to be understood that these embodiments are for illustration purposes and not limiting. Many additional embodiments will be apparent to persons of ordinary skill in the art reading this disclosure

What is claimed is:

1. A method of checking an input content for scams, the method to be performed by a scam checker that comprises a plurality of artificial intelligence (AI) models, the method comprising:
receiving the input content from a user device;
decomposing, by one of the plurality of AI models, the input content to one or more constituent data modalities of the input content;
generating, by one of the plurality of AI models, an evidence gathering plan based at least on the one or more constituent data modalities of the input content;
collecting, by one of the plurality of AI models, evidence based at least on the evidence gathering plan; and
evaluating, by one of the plurality of AI models, the collected evidence to generate a summary, wherein the summary includes a conclusion as to whether the input content is indicative of a scam.

2. The method of claim 1, wherein the summary includes a reasoning behind the conclusion.

3. The method of claim 1, wherein the user device is a smartphone, the input content is a screenshot of an app running on the smartphone, and the one or more constituent data modalities include an image data of the screenshot and a text of the screenshot.

4. The method of claim 3, wherein the evidence gathering plan includes checking a reputation service for a reputation of a poster the posted an image of the image data on a social media site.

5. The method of claim 3, wherein the evidence gathering plan includes searching the public Internet for an image of the image data.

6. The method of claim 1, wherein the user device is a smartphone, the input content is a text message, and the one or more constituent data modalities include a text of the text message.

7. A method of checking an input content for scams, the method comprising:
receiving a screenshot of a message on a smartphone employed by a user;
decomposing the screenshot into text;
evaluating the text, using an artificial intelligence (AI) model, for scams; and
alerting the user responsive to detecting that the input content is indicative of a scam.

8. The method of claim 7, further comprising:
decomposing the screenshot into image data; and
evaluating the image data, using an AI model, for scams.

9. The method of claim 7, wherein alerting the user includes generating a summary that includes a conclusion that the message is indicative of the scam and a reasoning behind the conclusion.

10. A method of checking contents for scams, the method to be performed by a scam checker that comprises a plurality of artificial intelligence (AI) models, the method comprising:
receiving a screenshot of an app of a smartphone employed by a user;
extracting, by one of the plurality of AI models, text from the screenshot;
generating, by one of the plurality of AI models, an evidence gathering plan based at least on the text;
collecting, by one of the plurality of AI models, evidence based at least on the evidence gathering plan;
evaluating, by one of the plurality of AI models, the collected evidence to generate a summary that indicates whether the screenshot includes information that is indicative of a scam; and
providing the summary to the user.

11. The method of claim 10, wherein the summary includes a conclusion that the text is indicative of the scam and a reasoning behind the conclusion.

12. The method of claim 10, wherein the evidence gathering plan includes checking a reputation service for a reputation of a poster that posted an image of the image data on a social media site.

13. The method of claim 10, further comprising:
decomposing the screenshot into image data,
wherein the evidence gathering plan includes searching the public Internet for an image of the image data.
